(19) United States
(12) Patent Application Publication
(10) Pub. No.: US 2019/0091820 A1
(43) Pub. Date: Mar. 28, 2019

(54) FLUID SUPPLY APPARATUS

(71) Applicant: SIO CO., LTD., Tokyo (JP)

(72) Inventors: Masuhiko Komazawa, Tokyo (JP); Masaru Ohki, Tokyo (JP)

(21) Appl. No.: 16/102,796

(22) Filed: Aug. 14, 2018

(30) Foreign Application Priority Data
Sep. 26, 2017 (KR) 2017-0124587

(51) Int. Cl. B23Q 11/10; B05B 1/34

(52) U.S. Cl. CPC B23Q 11/1084; B24B 55/02; B05B 1/3447

(57) ABSTRACT

A fluid supply apparatus according to an embodiment of the invention includes an internal structure and a housing such as a pipe body configured to house the internal structure. The internal structure includes a first portion, a second portion, a third portion, and a fourth portion formed integrally on a common shaft member having a circular cross-section. The first portion is positioned upstream of the housing when the internal structure is housed in the housing and includes a shaft portion and a at least one spiral vane. The second portion is positioned downstream from the first portion and includes a shaft portion and a plurality of protrusions. The third portion is positioned downstream from the second portion and includes a shaft portion and at least one spiral vane. The fourth portion is positioned downstream from the third portion and includes a shaft portion and a plurality of protrusions.

### CROSS-REFERENCE TO RELATED APPLICATIONS

This application is based upon and claims the benefit of priority under 35 USC 119 of Korean Patent Application No. 2017-0124587 filed on Sep. 26, 2017, the entire disclosure of which is incorporated herein by reference in its entirety for all purposes.

### BACKGROUND OF THE INVENTION

### 1. Field of the Invention

The present invention relates to a fluid supply apparatus for supplying a fluid. More specifically, the present invention relates to a fluid supply apparatus which provides a predetermined flow characteristic to a fluid flowing therethrough. For example, the present invention is applicable to a cutting fluid supply apparatus for various machine tools such as a grinding machine, a drilling machine, and a cutting machine.

### 2. Description of the Related Art

Conventionally, when a workpiece made of a metal or the like is machined into a desired shape by a machine tool such as the grinding machine or the drilling machine, a machining fluid (for example, coolant) is supplied to and around a contact portion between the workpiece and a tool (for example, a blade) to cool heat generated during machining or remove debris of the workpiece (also referred to as chips) from a machining spot. Cutting heat caused by high pressure and frictional resistance at the contact portion between the workpiece and the blade abrades the edge of the blade and lowers the strength of the blade, thereby reducing tool life of the blade. In addition, if the chips of the workpiece are not sufficiently removed, they can stick to the edge of the blade during machining, which may degrade machining accuracy.

The machining fluid (also referred to as a cutting fluid) decreases the frictional resistance between the tool and the workpiece, removes the cutting heat, and performs cleaning to remove the chips cut off from a surface of the workpiece. For this, the machining fluid should have a low coefficient of friction, a high boiling point, and good penetration into the contact portion between the blade and the workpiece.

For example, Japanese Patent Application Laid-Open Publication No. 1999-254281 published on Sep. 21, 1999 (published also as U.S. Pat. No. 6,095,899), discloses providing a gas emitting means for emitting a gas (for example, air) in a machining apparatus in order to forcibly infiltrate a machining liquid into a contact portion between a working element (i.e. a blade) and a workpiece.

According to the conventional technology as disclosed in the above patent document, the means for emitting the gas at a high speed and high pressure should be provided in the machining apparatus in addition to a means for spraying the machining liquid, thus increasing the cost and the size of the apparatus. Further, in the grinding machine, the machining liquid cannot sufficiently reach a contact portion between a grindstone and the workpiece because the air rotates along the outer circumferential surface of the grindstone together with the grindstone rotating at a high speed. Thus, there is still a problem that it is difficult to cool the heat generated during machining to a desired level because the machining liquid cannot sufficiently penetrate into the contact portion by simply emitting the air in the same direction as the rotation direction of the grindstone.

### SUMMARY OF THE INVENTION

The present invention was made in light of the problems mentioned above. An object of the present invention is to provide a fluid supply apparatus for providing a predetermined flow characteristic to a fluid flowing therethrough to improve lubricity, penetrability, and a cooling effect of the fluid.

In order to achieve the above object, an aspect of the present invention provides a fluid supply apparatus including an internal structure, and a housing such as a pipe body configured to house the internal structure and having an inlet and an outlet. The internal structure includes a first portion, a second portion, a third portion, and a fourth portion, which are formed integrally on a common shaft member having a circular cross-section. The first portion is positioned upstream of the housing when the internal structure is housed in the housing and includes a shaft portion and at least one spiral vane to swirl a fluid. The second portion is positioned downstream from the first portion and includes a shaft portion and a plurality of protrusions protruding from the outer circumferential surface of the shaft portion. The third portion is positioned downstream from the second portion and includes a shaft portion and at least one spiral vane to swirl a fluid. The fourth portion is positioned downstream from the third portion and includes a shaft portion and a plurality of protrusions protruding from the outer circumferential surface of the shaft portion.

Another aspect of the present invention provides an internal structure of a fluid supply apparatus including a first portion, a second portion, a third portion, and a fourth portion, which are formed integrally on a common shaft member having a circular cross-section. The fluid supply apparatus includes a housing, such as a pipe body, configured to house the internal structure. The first portion is positioned upstream of the housing when the internal structure is housed in the housing and includes a shaft portion and at least one spiral vane to swirl a fluid. The second portion is positioned downstream from the first portion and includes a shaft portion and a plurality of protrusions protruding from the outer circumferential surface of the shaft portion. The third portion is positioned downstream from the second portion and includes a shaft portion and at least one spiral vane to swirl a fluid. The fourth portion is positioned downstream from the third portion and includes a shaft portion and a plurality of protrusions protruding from the outer circumferential surface of the shaft portion.

If the fluid supply apparatus according to some embodiments of the present invention is provided in a fluid supply unit of a machine tool or the like, a cleaning effect is improved over the prior art due to vibration and impact generated during a process in which a plurality of fine bubbles (such as micro bubbles or smaller ultra-fine bubbles (so-called nano bubbles of the order of nanometer)) generated in the fluid supply apparatus collide with the tool and the workpiece and break. Thus, the life of the tool such as the blade can be extended and the cost of replacing the tool can be reduced. In addition, a flow characteristic provided by the fluid supply apparatus according to some embodiments of the present invention due to generation of fine bubbles can decrease the surface tension of the fluid and increase the penetrability and lubricity of the fluid. Thus, it is possible to improve the effect of cooling heat at the contact portion between the tool and the workpiece. According to many embodiments of the present invention, it is possible to increase the cooling effect and improve the lubricity by increasing the penetrability of the fluid, thereby enhancing the precision of machining.

Further, according to many embodiments of the present invention, the internal structure of the fluid supply apparatus is manufactured as one integrated component. By this, assembly of the internal structure with a housing is simplified. The fluid supply apparatus may be implemented as a fluid supply pipe. In this case, the fluid supply pipe includes the internal structure and a pipe body, and assembly of the internal structure with the pipe body is simplified.

The fluid supply apparatus of the present invention can be applied to a machining fluid supply unit in various machine tools such as the grinding machine, the cutting machine, and the drilling machine. It can also be effectively used in an apparatus for mixing two or more fluids (liquid and liquid, liquid and gas, or gas and gas). In addition, the present invention is applicable to various situations requiring supply of a fluid, such as a household shower nozzle or a hydroponics system. For example, a shower nozzle includes a fluid supply apparatus according to an embodiment of the present invention. Here, water of a predetermined temperature flows into the fluid supply apparatus, a predetermined flow characteristic is provided to the water, and the shower nozzle discharges the water from the fluid supply apparatus to improve a cleaning effect. In particular, due to the fine bubbles, the surface tension of the fluid decreases and the penetrability increases. As another example, a hydroponics system allows water to flow into the fluid supply apparatus, dissolved oxygen in the water increases through the fluid supply apparatus, and the water is discharged from the fluid supply apparatus.

### BRIEF DESCRIPTION OF THE DRAWINGS

The above and further objects and novel features of the present invention will more fully appear from the following detailed description when the same is read in conjunction with the accompanying drawings. It is to be expressly understood, however, that the drawings are for the purpose of illustration only and are not intended to limit the scope of the invention.

Here:

FIG. 1 shows a grinding machine including a fluid supply unit to which the present invention is applied.

FIG. 2 is a side exploded view of a fluid supply pipe according to a first embodiment of the present invention.

FIG. 3 is a side sectional view of the fluid supply pipe according to the first embodiment of the present invention.

FIG. 4 is a three-dimensional view of an internal structure of the fluid supply pipe according to the first embodiment of the present invention.

FIG. 5 is a side view of the internal structure of the fluid supply pipe according to the first embodiment of the present invention.

FIG. 6A is a front view of the internal structure of the fluid supply pipe according to the first embodiment of the present invention. FIG. 6B is a rear view of the internal structure.

FIG. 7 is a drawing for explaining a method for forming rhombic protrusions of the internal structure of the fluid supply pipe according to the first embodiment of the present invention.

FIG. 8 is a side exploded view of a fluid supply pipe according to a second embodiment of the present invention.

FIG. 9 is a side sectional view of the fluid supply pipe according to the second embodiment of the present invention.

FIG. 10 is a side exploded view of a fluid supply pipe according to a third embodiment of the present invention.

FIG. 11 is a side sectional view of the fluid supply pipe according to the third embodiment of the present invention.

FIG. 12 is a side view of an internal structure of the fluid supply pipe according to the third embodiment of the present invention.

FIG. 13 is a side exploded view of a fluid supply pipe according to a fourth embodiment of the present invention.

FIG. 14 is a side sectional view of the fluid supply pipe according to the fourth embodiment of the present invention.

FIG. 15 is a side view of an internal structure of the fluid supply pipe according to the fourth embodiment of the present invention.

FIG. 16 is a side exploded view of a fluid supply pipe according to a fifth embodiment of the present invention.

FIG. 17 is a side sectional view of the fluid supply pipe according to the fifth embodiment of the present invention.

FIG. 18 is a side view of an internal structure of the fluid supply pipe according to the fifth embodiment of the present invention.

FIG. 19 is a side exploded view of a fluid supply pipe according to a sixth embodiment of the present invention.

FIG. 20 is a side sectional view of the fluid supply pipe according to the sixth embodiment of the present invention.

FIG. 21 is a side exploded view of a fluid supply pipe according to a seventh embodiment of the present invention.

FIG. 22 is a side sectional view of the fluid supply pipe according to the seventh embodiment of the present invention.

### DETAILED DESCRIPTION OF THE PREFERRED EMBODIMENT

Embodiments in which the present invention is applied to machine tools such as a grinding machine will be mainly described herein. However, the field of application of the present invention is not intended to be limited to the illustrated examples. The present invention is applicable to various situations requiring supply of a fluid, such as a household shower nozzle, a fluid mixing apparatus, or a hydroponics system.

Hereinafter, the embodiments of the present invention will be described with reference to the accompanying drawings.

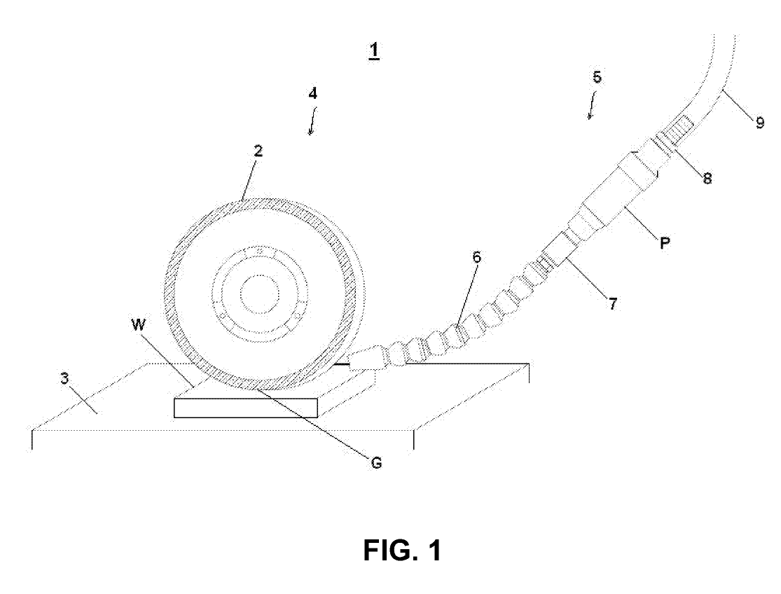

FIG. 1 shows an embodiment of a grinding machine including a fluid supply unit to which the present invention is applied. As shown, a grinding machine 1 includes a grinding unit 4 including a grinding blade (a grindstone) 2, a table 3 for moving a workpiece W in two dimensions, and a column for vertically moving the workpiece W or the grinding blade 2 (not shown in the drawing), and a fluid supply unit 5 for supplying a fluid (i.e. coolant) to the grinding blade 2 or the workpiece W. For example, the fluid is water. The grinding blade 2 is rotationally driven in the clockwise direction in the plane of FIG. 1 by a driving source (not shown in the drawing). A surface of the workpiece W is ground by friction between the outer circumferential surface of the grinding blade 2 and the workpiece W at a grinding spot G. Although not shown in the drawing, the fluid supply unit 5 includes a tank in which the fluid is stored and a pump for discharging the fluid from the tank.

The fluid supply unit 5 includes a nozzle 6 having an outlet through which the fluid is discharged toward the grinding blade 2 and the workpiece W, a fluid supply pipe P including an internal structure for providing a predetermined flow characteristic to the fluid, and a delivery pipe 9 into which the fluid stored in the tank is flowed by the pump. The fluid supply pipe P is an example of a fluid supply apparatus of the present invention. A joint 7 connects the nozzle 6 and an outlet side of the fluid supply pipe P. A joint 8 connects the delivery pipe 9 and an inlet side of the fluid supply pipe P. The fluid flowing into the fluid supply pipe P from the delivery pipe 9 has a predetermined flow characteristic provided by the internal structure while passing though the fluid supply pipe P. The fluid is discharged toward the grinding spot G from an outlet of the fluid supply pipe P through the nozzle 6. According to many embodiments of the present invention, the fluid passing through the fluid supply pipe P includes fine bubbles. Hereinafter, various embodiments of the fluid supply pipe P will be described with reference to the drawings. Note that the fluid supply pipe P is not limited to a pipe as shown in the various embodiments hereinafter. The pipe body may be changed to various types of housing or container having a specific outside appearance. However, the inner surface of the housing preferably forms a cylinder.

### First Embodiment

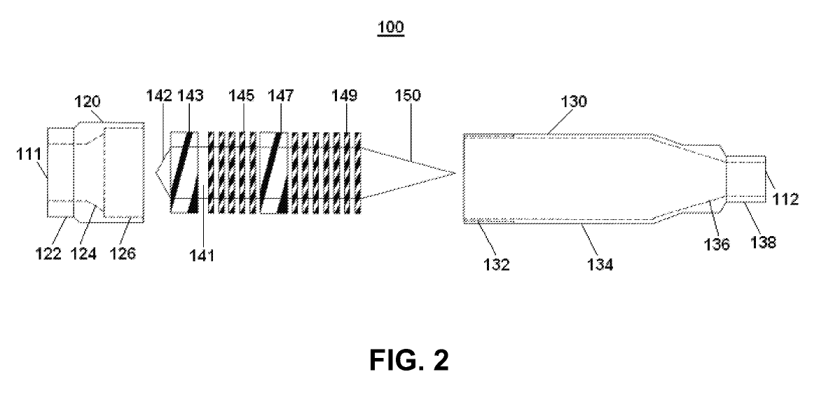

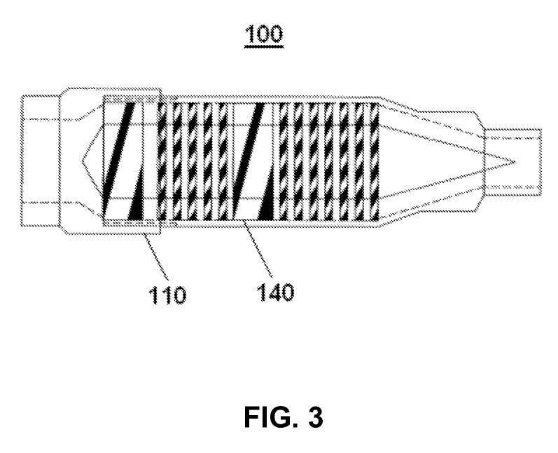

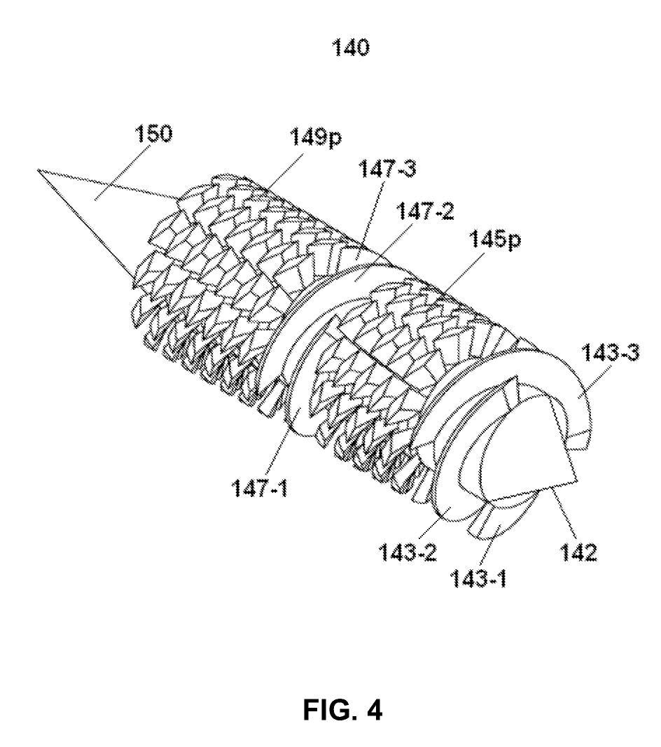

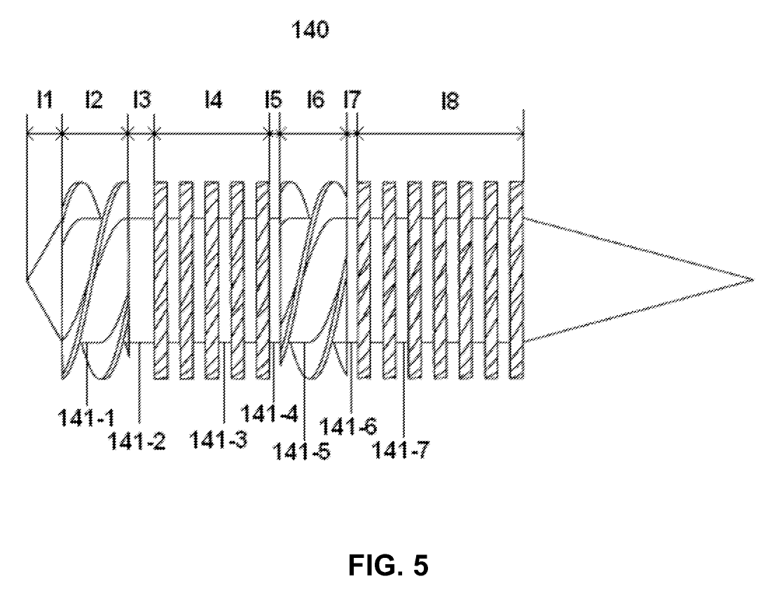

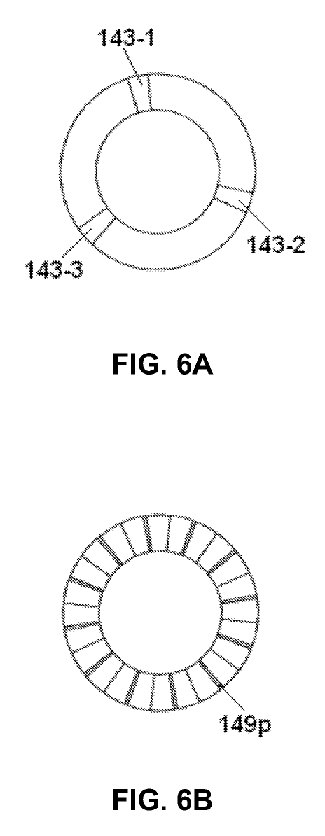

FIG. 2 is a side exploded view of a fluid supply pipe 100 according to a first embodiment of the present invention, and FIG. 3 is a side sectional view of the fluid supply pipe 100. FIG. 4 is a three-dimensional view of an internal structure 140 of the fluid supply pipe 100, and FIG. 5 is a side view of the internal structure 140. FIGS. 6A and 6B a front view and a rear view of the internal structure 140, respectively. As shown in FIGS. 2 and 3, the fluid supply pipe 100 includes a pipe body 110 and the internal structure 140. In FIGS. 2 and 3, the fluid flows from an inlet 111 to an outlet 112.

The pipe body 110 functions as a housing or a container to house the internal structure 140 in the internal cylindrical space. The pipe body 110 includes an inlet side member 120 and an outlet side member 130. In the present embodiment, each of the inlet side member 120 and the outlet side member 130 is formed in a hollow tube shape. The inlet side member 120 has the inlet 111 having a predetermined diameter at one end and a female screw 126 for connection with the outlet side member 130 which is formed by thread-cutting an inner circumferential surface of the inlet side member 120 at the other end. A connecting portion 122 is formed on the side of the inlet 111 and is coupled with the joint 8 (see FIG. 1). For example, the inlet side member 120 and the joint 8 are coupled by engaging a female screw formed on an inner circumferential surface of the connecting portion 122 with a male screw formed on an outer circumferential surface of one end of the joint 8. In the present embodiment, the inner diameters of the both ends of the inlet side member 120, i.e. the inner diameter of the inlet 111 and the inner diameter of the female screw 126 are different from each other, and the inner diameter of the inlet 111 is smaller than the inner diameter of the female screw 126, as shown in FIG. 2. A tapered portion 124 is formed between the inlet 111 and the female screw 126. However, the present invention is not limited to this embodiment. In another embodiment, the inner diameters of the both ends of the inlet side member 120 are the same.

The outlet side member 130 has the outlet 112 having a predetermined diameter at one end and a male screw 132 for connection with the inlet side member 120 which is formed by thread-cutting an outer circumferential surface of the outer side member 130 at the other end. The diameter of the outer circumferential surface of the male screw 132 of the outlet side member 130 is the same as the inner diameter of the female screw 126 of the inlet side member 120. A connecting portion 138 is formed on the side of the outlet 112 and is coupled with the joint 7 (see FIG. 1). For example, the outlet side member 130 and the joint 7 are coupled by engaging a female screw formed on an inner circumferential surface of the connecting portion 138 with a male screw formed on an outer circumferential surface of one end of the joint 7. A tubular portion 134 and a tapered portion 136 are formed between the male screw 132 and the connecting portion 138. In the present embodiment, the inner diameters of the both ends of the outlet side member 130, i.e. the inner diameter of the outlet 112 and the inner diameter of the male screw 132 are different from each other, and the inner diameter of the outlet 112 is smaller than the inner diameter of the male screw 132. However, the present invention is not limited to this embodiment. In another embodiment, the inner diameters of the both ends of the outlet side member 130 are the same. The pipe body 110 is formed by connecting the inlet side member 120 and the outlet side member 130 by screw-joining the female screw 126 of the inner circumferential surface of one end of the inlet side member 120 and the male screw 132 of the outer circumferential surface of one end of the outlet side member 130.

The above described configuration of the pipe body 110 is merely an embodiment, and the present invention is not limited to the configuration. For example, connection of the inlet side member 120 and the outlet side member 130 is not limited to the screw-joining and any method for connecting mechanical components known in the art is applicable. Further, the shapes of the inlet side member 120 and the outlet side member 130 are not limited to those shown in FIGS. 2 and 3, respectively. A designer of the fluid supply pipe 100 may arbitrarily design the inlet side member 120 and the outlet side member 130 or change their shapes according to applications of the fluid supply pipe 100. Each of the inlet side member 120 and the outlet side member 130 can be made of a metal such as steel, plastic, or the like.

Referring to FIGS. 2 and 3, the fluid supply pipe 100 is assembled by housing the internal structure 140 in the outlet side member 130, and then engaging the male screw 132 of the outer circumferential surface of the outlet side member 130 with the female screw 126 of the inner circumferential surface of the inlet side member 120. The internal structure 140 can be formed by processing a cylindrical member made of a metal such as steel or by molding plastic, for example. As shown in FIGS. 2 and 4, the internal structure 140 includes a fluid diffusing portion 142, a first swirl generating portion 143, a first bubble generating portion 145, a second swirl generating portion 147, a second bubble generating portion 149, and a conical guiding portion 150, which are formed integrally on a common shaft member 141 having a circular cross-section. As will be described in the following, the shaft member 141 of the present embodiment has the same diameter at the first swirl generating portion 143, the first bubble generating portion 145, the second swirl generating portion 147, and the second bubble generating portion 149. The diameter of a portion of the fluid diffusing portion 142 of which cross-sectional area is the maximum is the same as the diameter of a shaft portion 141-1 of the first swirl generating portion 143. Each of the fluid diffusing portion 142, the first swirl generating portion 143, the first bubble generating portion 145, the second swirl generating portion 147, the second bubble generating portion 149, and the guiding portion 150 can be formed by machining a part of a cylindrical member, for example.

In the present embodiment, the fluid diffusing portion 142 has a shape of a cone. For example, the fluid diffusing portion 142 is formed by machining one end of the cylindrical member in a cone shape. The fluid diffusing portion 142 diffuses the fluid flowing into the inlet side member 120 through the inlet 111 outward from the center of the pipe, i.e. radially. When the internal structure 140 is housed in the pipe body 110, the fluid diffusing portion 142 is placed at a position corresponding to the tapered portion 124 of the inlet side member 120 (see FIGS. 2 and 3). Although the fluid diffusing portion 142 has the cone shape in the present embodiment, the present invention is not limited thereto. In another embodiment, the fluid diffusing portion 142 is formed in a dome shape. The fluid diffusing portion 142 may have any other shape that is gradually enlarged concentrically from an apex. In another embodiment, the internal structure 140 has no fluid diffusing portion. These modifications can also be applied to other embodiments which will be described later.

The first swirl generating portion 143 is formed downstream of the fluid diffusing portion 142, as shown in FIGS. 4 and 5. The first swirl generating portion 143 includes the shaft portion 141-1 having a circular cross-section and a constant diameter and three spiral vanes 143-1, 143-2, and 143-3. As shown in FIG. 5, the length of the first swirl generating portion 143 (12) is longer than the length of the fluid diffusing portion 142 (11) and is shorter than the length of the first bubble generating portion 145 (14) in the present embodiment. The diameter of the portion of the fluid diffusing portion 142 of which cross-sectional area is the maximum is the same as the diameter of the shaft portion 141-1 of the first swirl generating portion 143 in the present embodiment. In another embodiment, the diameter of the portion of the fluid diffusing portion 142 of which cross-sectional area is the maximum is smaller than the diameter of the shaft portion 141-1. In another embodiment, the diameter of the portion of the fluid diffusing portion 142 of which cross-sectional area is the maximum is larger than the diameter of the shaft portion 141-1. In this case, it is preferable that the radius of the portion of the fluid diffusing portion 142 of which cross-sectional area is the maximum is smaller than the radius of the first swirl generating portion 143 (i.e. the distance from the center of the shaft portion 141-1 to the end of each of the vanes of the first swirl generating portion 143). Each of the vanes 143-1, 143-2, and 143-3 of the first swirl generating portion 143 has its end spaced by 120 degrees from each other in the circumferential direction of the shaft portion 141-1. The vanes 143-1, 143-2, and 143-3 are formed in a spiral shape in the counterclockwise direction at a predetermined interval on the outer circumferential surface from one end to the other end of the shaft portion 141-1. The number of the vanes is three in the present invention, but the present invention is not limited this embodiment. Further, the shape of the vanes 143-1, 143-2, and 143-3 of the first swirl generating portion 143 is not particularly limited if the vanes can cause swirling flow of the fluid which has been diffused by the fluid diffusing portion 142 and has flowed into the first swirl generating portion 143 while the fluid passes between the vanes. In the present embodiment, the outer diameter of the first swirl generating portion 143 is such that it is close to the inner circumferential surface of the tubular portion 134 of the outlet side member 130 of the pipe body 110 when the internal structure 140 is housed in the pipe body 110.

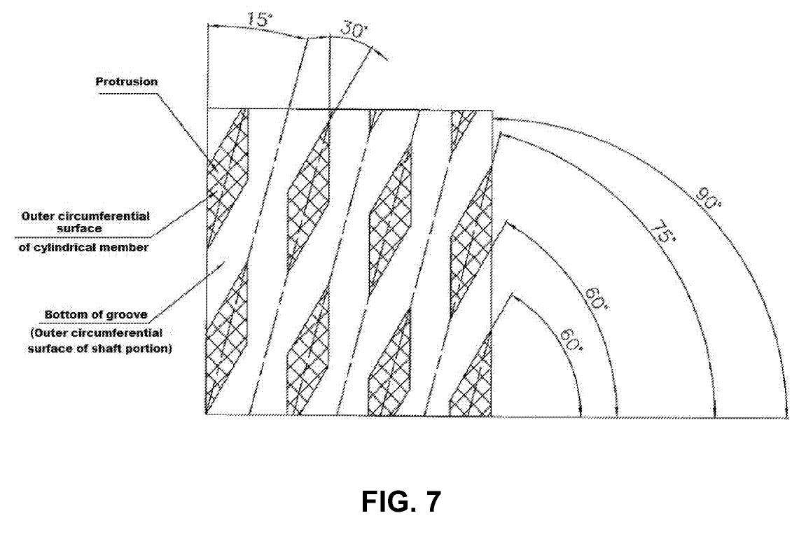

The first bubble generating portion 145 is formed downstream of the fluid diffusing portion 142 and the first swirl generating portion 143. As shown in FIGS. 4 and 5, the first bubble generating portion 145 includes a shaft portion 141-3 having a circular cross-section and a constant diameter and a plurality of protrusions 145p protruding from the outer circumferential surface of the shaft portion 141-3. The plurality of protrusions 145p of the first bubble generating portion 145 are formed in a net shape and each protrusion is in the form of a pillar having a rhombic (i.e. diamond-shaped) cross-section. Each of the plurality of rhombic protrusions 145p is formed, for example, by grinding the cylindrical member so as to protrude outward radially from the outer circumferential surface of the shaft portion 141-3. More specifically, FIG. 7 shows an exemplary method for forming the rhombic protrusions 145p. A plurality of lines with predetermined spacing therebetween in the direction of 90 degrees with respect to the longitudinal direction of the cylindrical member and a plurality of lines having a predetermined angle (for example, 60 degrees) with respect to the longitudinal direction with predetermined spacing therebetween are intersected with each other. Spaces between the lines in the direction of 90 degrees are ground alternately, and spaces between the tilted lines are ground alternately. By this, the plurality of rhombic protrusions 145p protruding from the outer circumferential surface of the shaft portion 141-3 are formed regularly and alternately in the vertical direction (the circumferential direction of the shaft portion 141-3) and the horizontal direction (the longitudinal direction of the shaft portion 141-3). The bottom of a groove formed between the protrusions 145p by grinding forms the outer circumferential surface of the shaft portion 141-3. Further, in the present embodiment, the outer diameter of the first bubble generating portion 145 is such that it is close to the inner circumferential surface of the tubular portion 134 of the outlet side member 130 of the pipe body 110 when the internal structure 140 is housed in the pipe body 110. The cross-section of each of the plurality of protrusions 145p may not be rhombic (for example, the shape of the cross-section may be a triangle or another polygon), and the arrangement of the protrusions 145p may be modified by changing the angle of the lines, the width between the protrusions, and the like. These modifications can also be applied to other embodiments which will be described later. While the rhombic protrusions 145p are formed by grinding in the present embodiment, they are formed by another method. For example, machining time can be shortened by combining cutting, turning, and the like, instead of grinding. Such various machining methods are also applicable to rhombic protrusions 149p described later and to other embodiments.

In the present embodiment, the diameter of the shaft portion 141-1 of the first swirl generating portion 143 is the same as the diameter of the shaft portion 141-3 of the first bubble generating portion 145, as shown in FIGS. 2 and 5. Thus, a shaft portion 141-2 between the first swirl generating portion 143 and the first bubble generating portion 145 has the same diameter as the shaft portions 141-1 and 141-3. In addition, the length of the shaft portion 141-2 (13) is shorter than 12 which is the length of the shaft portion 141-1 of the first swirl generating portion 143 and shorter than 11 which is the length of the fluid diffusing portion 142. However, the present invention is not limited to this embodiment.

The second swirl generating portion 147 is formed downstream of the first bubble generating portion 145, as shown in FIGS. 4 and 5. the second swirl generating portion 147 includes a shaft portion 141-5 having a circular cross-section and a constant diameter and three spiral vanes 147-1, 147-2, and 147-3. The diameter of the shaft portion 141-3 of the first bubble generating portion 145 is the same as the diameter of the shaft portion 141-5 of the second swirl generating portion 147. Thus, a shaft portion 141-4 between the first bubble generating portion 145 and the second swirl generating portion 147 also has the same diameter. The length of the shaft portion 141-5 of the second swirl generating portion 147 (16) is the same as the length of the shaft portion 141-1 of the first swirl generating portion 143 (12). The length of the shaft portion 141-4 (15) is shorter than the length of the shaft portion 141-5 of the second swirl generating portion 147 (16) (or the length of the shaft portion 141-1 of the first swirl generating portion 143 (12)). The present invention is not limited to this embodiment. in another embodiment, the length of the shaft portion 141-5 of the second swirl generating portion 147 (16) is different from the length of the shaft portion 141-1 of the first swirl generating portion 143 (12). Each of the vanes 147-1, 147-2, and 147-3 of the second swirl generating portion 147 has its end spaced by 120 degrees from each other in the circumferential direction of the shaft portion 141-5. The vanes 147-1, 147-2, and 147-3 are formed in a spiral shape in the counterclockwise direction at a predetermined interval on the outer circumferential surface from one end to the other end of the shaft portion 141-5. The number of the vanes is three in the present invention, but the present invention is not limited this embodiment. Further, the shape of the vanes 147-1, 147-2, and 147-3 of the second swirl generating portion 147 is not particularly limited if the vanes can cause swirling flow of the fluid while the fluid passes between the vanes. In the present embodiment, the outer diameter of the second swirl generating portion 147 is such that it is close to the inner circumferential surface of the tubular portion 134 of the outlet side member 130 of the pipe body 110 when the internal structure 140 is housed in the pipe body 110.

The second bubble generating portion 149 is formed downstream of the second swirl generating portion 147. Similarly to the first bubble generating portion 145, the second bubble generating portion 149 includes a shaft portion 141-7 having a circular cross-section and a constant diameter and a plurality of rhombic protrusions 149p protruding from the outer circumferential surface of the shaft portion 141-7 and the plurality of rhombic protrusions 149p are formed in a net shape (see FIGS. 4 and 5). Each of the plurality of rhombic protrusions 149p is formed, for example, by grinding the cylindrical member so as to protrude outward radially from the outer circumferential surface of the shaft portion 141-7. The rhombic protrusions 149p can be formed by the same method as the rhombic protrusions 145p of the first bubble generating portion 145 (see FIG. 7). In the present embodiment, the outer diameter of the second bubble generating portion 149 is such that it is close to the inner circumferential surface of the tubular portion 134 of the outlet side member 130 of the pipe body 110 when the internal structure 140 is housed in the pipe body 110.

In the present embodiment, the diameter of the shaft portion 141-5 of the second swirl generating portion 147 is the same as the diameter of the shaft portion 141-7 of the second bubble generating portion 149, as shown in FIGS. 2 and 5. Thus, a shaft portion 141-6 between the second swirl generating portion 147 and the second bubble generating portion 149 has the same diameter as the shaft portions 141-5 and 141-7. In addition, the length of the shaft portion 141-7 of the second bubble generating portion 149 (18) is longer that 14 which is the length of the shaft portion 141-3 of the first bubble generating portion 145. Thus, the number of the protrusions 149p of the second bubble generating portion 149 is larger than the number of the protrusions 145p of the first bubble generating portion 145. The length of the shaft portion 141-6 (17) is shorter than 16 which is the length of the shaft portion 141-5 of the second swirl generating portion 147 and shorter than 18 which is the length of the shaft portion 141-7 of the second bubble generating portion 149. Further, the length of the shaft portion 141-6 (17) is shorter than the length of the shaft portion 141-2 (13). However, the present invention is not limited to this embodiment. In another embodiment, the length of the shaft portion 141-7 of the second bubble generating portion 149 (18) is the same as the length of the shaft portion 141-3 of the first bubble generating portion 145 (14).

The guiding portion 150 is formed by machining the downstream end of the cylindrical member in a cone shape. The guiding portion 150 guides the fluid flowing inside the fluid supply pipe 100 toward the center of the fluid supply pipe 100 so that the fluid can be smoothly discharged through the outlet 112, as described later. In another embodiment, the internal structure 140 includes no guiding portion.

FIGS. 6A and 6B are a front view and a rear view of the internal structure 140, respectively. More specifically, FIG. 6A shows the internal structure 140 viewed from the inlet 111 side of the fluid supply pipe 100, and FIG. 6B shows the internal structure 140 viewed from the outlet 112 side of the fluid supply pipe 100. As shown in FIG. 6A, the three vanes 143-1, 143-2, and 143-3 of the first swirl generating portion 143 are separated from each other by 120 degrees in the circumferential direction of the shaft portion 141-1. Further, as shown in FIG. 6B, the second bubble generating portion 149 has the plurality of protrusions 149p protruding from the outer circumferential surface of the shaft portion 141-7.

Now, flow of the fluid passing through the fluid supply pipe 100 is described. The fluid enters the inlet 111 of the fluid supply pipe 100 through the delivery pipe 9 (see FIG. 1) by an electric pump whose impeller rotates clockwise or counterclockwise. The fluid bumps into the fluid diffusing portion 142 and diffuses outward from the center of the fluid supply pipe 100 (i.e. radially) while passing through the inner space of the tapered portion 124 of the inlet side member 120. The diffused fluid passes between the three vanes 143-1, 143-2, and 143-3 of the first swirl generating portion 143 formed in the spiral shape. The fluid diffusing portion 142 induces the fluid flowing into the fluid supply pipe 100 through the delivery pipe 9 to enter the first swirl generating portion 143 effectively. The fluid vigorously swirls due to the vanes of the first swirl generating portion 143 and is sent to the first bubble generating portion 145 through the shaft portion 141-2.

Then, the fluid passes between the plurality of rhombic protrusions 145p of the first bubble generating portion 145. The plurality of rhombic protrusions 145p form a plurality of narrow spiral flow paths. As the fluid passes through the plurality of narrow flow paths formed by the plurality of rhombic protrusions 145p, a large number of minute vortices are generated. This causes mixing and diffusion of the fluid. The structure of the first bubble generating unit 145 is also useful when two or more fluids having different properties need to be mixed.

The internal structure 140 is configured such that the fluid flows from the upstream side (the first swirl generating portion 143) having a large cross-sectional area to the downstream side (the flow paths formed between the plurality of rhombic protrusions 145p of the first bubble generating portion 145) having a small cross-sectional area in the fluid supply pipe 100. This configuration changes static pressure of the fluid as described below. The relationship between pressure, velocity, and potential energy with no external energy to a fluid is given by the Bernoulli equation.

$$p + \frac{ρ {v}^{2}}{2} + gh ρ = k$$

Here, p is the pressure at a point on a streamline, p is the density of the fluid, v is the fluid flow speed at the point, g is the gravitational acceleration, h is the height of the point with respect to a reference plane, and k is a constant. The Bernoulli's law expressed as the above equation is the energy conservation law applied to fluids and explains that the sum of all the forms of energy on a streamline is constant for flowing fluids at all times. According to the Bernoulli's law, the fluid velocity is low and the static pressure is high in the upstream side having the large cross-sectional area. On the other hand, the fluid velocity is increased and the static pressure is lowered in the downstream side having the small cross-sectional area.

In the case that the fluid is a liquid, the liquid begins to vaporize when the lowered static pressure reaches the saturated vapor pressure of the liquid. Such a phenomenon in which a liquid is rapidly vaporized because the static pressure becomes lower than the saturated vapor pressure (for water, 3000 to 4000 Pa for water) in extremely short time at almost constant temperature is called cavitation. The internal structure of the fluid supply pipe 100 of the present invention causes the cavitation phenomenon. Due to the cavitation phenomenon, the liquid is boiled with minute bubbles of a particle size less than 100 microns existing in the liquid as nuclei or many minute bubbles are generated due to isolation of dissolved gas. That is, many fine bubbles are generated while the fluid passes the first bubble generating portion 145.

In the case of water, one water molecule can form hydrogen bonds with four other water molecules, and this hydrogen bonding network is not easy to break down. Thus, the water has much higher boiling point and melting point than other liquids that do not form hydrogen bonds, and is highly viscous. Since the water having the high boiling point exhibits an excellent cooling effect, the water is frequently used as the coolant for the machine tool for performing operations such as grinding. However, the water has a problem that the size of the water molecule is large and its penetrability to a machining spot and/or lubricity is not so good. Thus, conventionally, a special lubricant (i.e. cutting oil) other than the water is frequently used alone or in combination with the water. In the case of using the fluid supply pipe of the present invention, the cavitation phenomenon described above causes vaporization of the water and, as a result, the hydrogen bonding network of the water is destroyed to lower the viscosity. Further, the fine bubbles generated by the vaporization lowers surface tension of the water to improve the penetrability and lubricity. The improved penetrability results in increased cooling efficiency. Therefore, according to many embodiment of the present invention, it is possible to improve machining quality (i.e. the performance of the machine tool) even if only water is used without using any special lubricant.

The fluid which has passed the first bubble generating unit 145 passes the shaft portion 141-4 and between the three spiral vanes 147-1, 147-2, and 147-3 of the second swirl generating portion 147. The fluid vigorously swirls due to the vanes of the second swirl generating portion 147 and is sent to the second bubble generating portion 149 through the shaft portion 141-6. As the fluid passes through a plurality of narrow flow paths formed by the plurality of rhombic protrusions 149p, a phenomenon in which a large number of minute vortices are generated occurs, as described in connection with the first bubble generating portion 145. Further, the configuration in which the fluid flows from a flow path having a large cross-sectional area (formed by the three vanes of the second swirl generating portion 147) to the flow paths having a small cross-sectional area (formed between the plurality of rhombic protrusions 149p of the second bubble generating portion 149) causes the cavitation phenomenon. As a result, a large number of fine bubbles are generated as the fluid passes the second bubble generating portion 149.

As described above, the fluid supply pipe 100 according to the present embodiment is configured such that the fluid which has passed the first swirl generating portion 143 and the first bubble generating portion 145 passes between the spiral vanes 147-1 to 147-3 of the second swirl generating portion 147 and the plurality of protrusions 149p of the second bubble generating portion 149. The second swirl generating portion 147 provided upstream of the second bubble generating portion 149 generates a swirling flow and supplies it to the second bubble generating portion to increase the effect of generating fine bubbles as compared with a fluid supply pipe provided with one bubble generating portion.

The fluid which has passed the second bubble generating unit 149 flows through the tapered portion 136 toward the end of the internal structure 140. The tapered portion 136 has a flow path whose cross section is much larger than that of the narrow flow paths of the second bubble generating portion 149. Since the fluid flows from a plurality of narrow flow paths formed by the plurality of protrusions of the second bubble generating portion 149 to the tapered portion 136 of the outlet side member 130, a path through which the fluid flows is rapidly widened. Due to the conical surface of the guiding portion 150 of the internal structure 140, a Coanda effect occurs. The Coanda effect is the phenomenon in which a fluid flowing around a curved surface is drawn to the curved surface due to a pressure drop between the fluid and the curved surface and thus the fluid flows along the curved surface. Due to the Coanda effect, the fluid is induced to flow along the surface of the guiding portion 150. The fluid is guided toward the center of the pipe by the tapered portion 136 of the outlet side member 130 and the guiding portion 150 of the internal structure 140, flows out of the outlet 112, and is discharged toward the grinding spot G through the nozzle 6. When the fluid is discharged through the nozzle 6, the many fine bubbles generated by the first bubble generating portion 145 and the second bubble generating portion 149 are exposed to atmospheric pressure. Then, the fine bubbles collide with the grinding blade 2 and the workpiece W and break, or explode and disappear. Vibration and shock generated during the extinction of the bubbles effectively remove sludge or chips generated at the grinding spot G. In other words, the cleaning effect around the grinding spot G is improved as the fine bubbles disappear.

By providing the fluid supply unit of the machine tool with the fluid supply pipe 100 of the embodiment of the present invention, it is possible to cool the heat generated in the grinding blade and the workpiece more effectively than by using a conventional fluid supply unit. Further, the penetrability and lubricity of the fluid are improved, thereby enhancing the precision of machining. Furthermore, by effectively removing the debris of the workpiece from the machining spot, it is possible to extend the service life of the tool such as the cutting blade and reduce the cost of replacing the tool.

In addition, since the fluid diffusing portion 142, the first swirl generating portion 143, the first bubble generating portion 145, the second swirl generating portion 147, the second bubble generating portion 149, and the guiding portion 150 of the internal structure 140 are formed by processing one member according to the present embodiment, the internal structure 140 is manufactured as a single integrated component. Therefore, it is possible to manufacture the fluid supply pipe 100 only by a simple process of inserting the internal structure 140 into the outlet side member 130 and then coupling the outlet side member 130 and the inlet side member 120 (for example, by engaging the male screw 132 of the outlet side member 130 with the female screw 126 of the inlet side member 120).

The fluid supply pipe of the present invention can be applied to a machining liquid supply unit in various machine tools such as the grinding machine, the cutting machine, and the drilling machine. In addition, the fluid supply pipe of the present invention can be effectively used in an apparatus for mixing two or more kinds of fluids (for example, liquid and liquid, liquid and gas, or gas and gas). For example, in the case of applying the fluid supply pipe of the present invention to a combustion engine, combustion efficiency can be improved by sufficiently mixing fuel and air. Further, in the case of applying the fluid supply pipe of the present invention to a cleaning apparatus, a cleaning effect can be further improved compared to a conventional cleaning apparatus. As another example, by employing the fluid supply pipe of the present invention in a hydroponics system, it is possible to increase dissolved oxygen in water supplied by the system to maintain or raise the oxygen amount (i.e. dissolved oxygen concentration) in the water.

### Second Embodiment

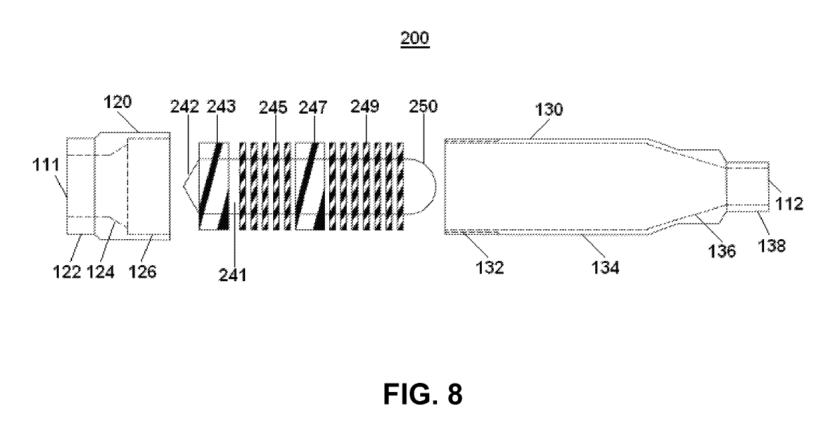

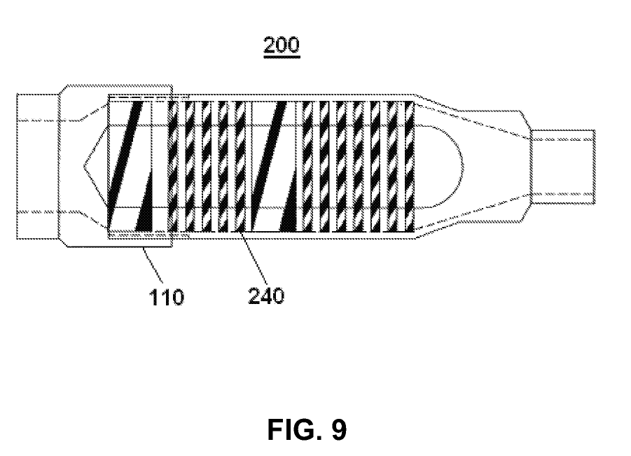

Referring to FIGS. 8 and 9, a fluid supply pipe 200 according to a second embodiment of the present invention will be described below. Descriptions of the same features as those of the first embodiment will be omitted, and only differences from the first embodiment will be described in detail. The same reference numerals are used for the same features as those of the first embodiment. FIG. 8 is a side exploded view of the fluid supply pipe 200 according to the second embodiment of the present invention, and FIG. 9 is a side sectional view of the fluid supply pipe 200. As shown in FIGS. 8 and 9, the fluid supply pipe 200 includes the pipe body 110 and an internal structure 240. Since the pipe body 110 of the second embodiment is the same as that of the first embodiment, descriptions thereof will be omitted. In FIGS. 8 and 9, a fluid flows from the inlet 111 to the outlet 112. As shown in FIG. 9, the fluid supply pipe 200 is assembled by inserting the internal structure 240 into the outlet side member 130 and then engaging the male screw 132 of the outer circumferential surface of the outlet side member 130 with the female screw 126 of the inner circumferential surface of the inlet side member 120.

The internal structure 240 of the second embodiment includes a fluid diffusing portion 242, a first swirl generating portion 243, a first bubble generating portion 245, a second swirl generating portion 247, a second bubble generating portion 249, and a guiding portion 250, from the upstream side to the downstream side, which are formed integrally on a common shaft member 241 having a circular cross-section. For example, the internal structure 240 is formed by machining one cylindrical member. In the present embodiment, the shaft member 241 of the present embodiment has the same diameter at the first swirl generating portion 243, the first bubble generating portion 245, the second swirl generating portion 247, and the second bubble generating portion 249. The diameter of a portion of the fluid diffusing portion 242 of which cross-sectional area is the maximum is the same as the diameter of a shaft portion of the first swirl generating portion 243. Each of the fluid diffusing portion 242, the first swirl generating portion 243, the first bubble generating portion 245, the second swirl generating portion 247, and the second bubble generating portion 249 has a similar structure and can be formed by a similar method as each of the fluid diffusing portion 142, the first swirl generating portion 143, the first bubble generating portion 145, the second swirl generating portion 147, and the second bubble generating portion 149 of the first embodiment, respectively.

Although the fluid diffusing portion 242 is formed in a cone shape in the present embodiment, the present invention is not limited thereto. In another embodiment, the fluid diffusing portion 242 is formed in a dome shape. In further another embodiment, the internal structure 140 has no fluid diffusing portion. While the internal structure 140 according to the first embodiment has the conical guiding portion 150, the internal structure 240 according to the second embodiment has the dome-shaped guiding portion 250. For example, the guiding portion 250 is formed by machining the downstream end of the cylindrical member in the shape of a dome.

The fluid entering the fluid supply pipe 200 is diffused by the fluid diffusing portion 242 and passes the first swirl generating portion 243, the first bubble generating portion 245, the second swirl generating portion 247, and the second bubble generating portion 249, sequentially. Since the fluid flows from a plurality of narrow flow paths formed by a plurality of protrusions of the second bubble generating portion 249 to the tapered portion 136 of the outlet side member 130, a path through which the fluid flows is rapidly widened. At this time, the dome-shaped guiding portion 250 causes the Coanda effect. Due to the Coanda effect, the fluid is induced to flow along the surface of the guiding portion 250. The fluid induced by the dome-shaped guiding portion 250 toward the center of the pipe passes the tapered portion 136 and flows out of the outlet 112. The fine bubbles generated by the two bubble generating portions 245 and 249 improve the cooling function and the cleaning effect of the fluid compared with a conventional pipe.

### Third Embodiment

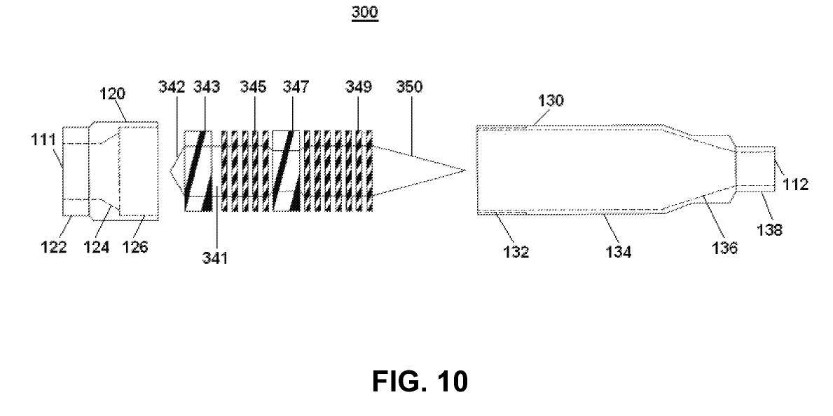

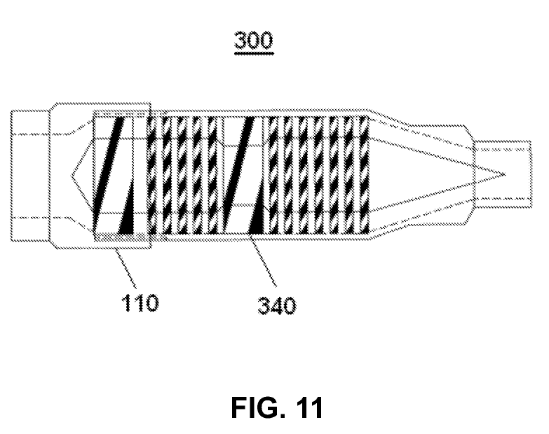

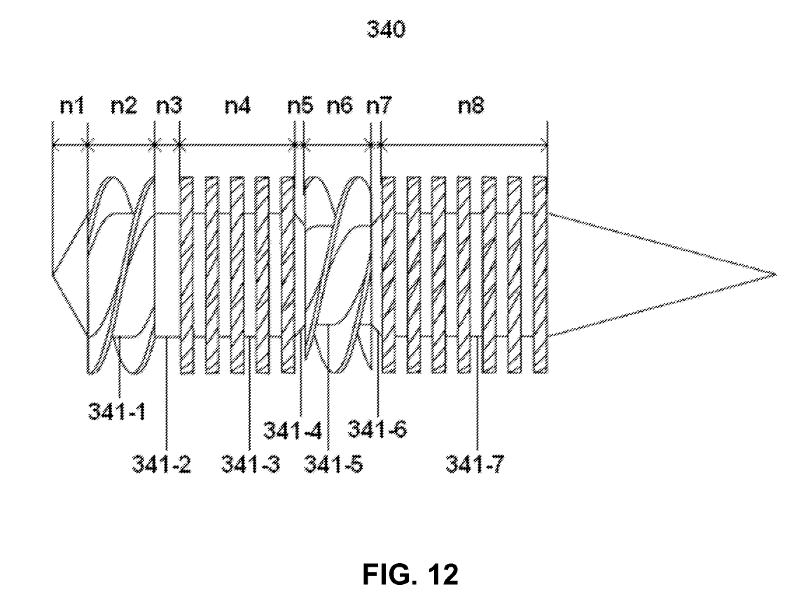

Referring to FIGS. 10 to 12, a fluid supply pipe 300 according to a third embodiment of the present invention will be described below. Descriptions of the same features as those of the first embodiment will be omitted, and only differences from the first embodiment will be described in detail. The same reference numerals are used for the same features as those of the first embodiment. FIG. 10 is a side exploded view of the fluid supply pipe 300 according to the third embodiment of the present invention, FIG. 11 is a side sectional view of the fluid supply pipe 300, and FIG. 12 is a side view of an internal structure 340 of the fluid supply pipe 300.

As shown in FIGS. 10 and 11, the fluid supply pipe 300 includes the pipe body 110 and the internal structure 340. Since the pipe body 110 of the third embodiment is the same as that of the first embodiment, descriptions thereof will be omitted. In FIGS. 10 and 11, a fluid flows from the inlet 111 to the outlet 112. As shown in FIG. 11, the fluid supply pipe 300 is assembled by inserting the internal structure 340 into the outlet side member 130 and then engaging the male screw 132 of the outer circumferential surface of the outlet side member 130 with the female screw 126 of the inner circumferential surface of the inlet side member 120.

The internal structure 340 of the third embodiment includes a fluid diffusing portion 342, a first swirl generating portion 343, a first bubble generating portion 345, a second swirl generating portion 347, a second bubble generating portion 349, and a conical guiding portion 350, from the upstream side to the downstream side, which are formed integrally on a common shaft member 341 having a circular cross-section. Each of the fluid diffusing portion 342, the first swirl generating portion 343, the first bubble generating portion 345, the second swirl generating portion 347, the second bubble generating portion 349, and the guiding portion 350 has a similar structure and can be formed by a similar method as each of the fluid diffusing portion 142, the first swirl generating portion 143, the first bubble generating portion 145, the second swirl generating portion 147, the second bubble generating portion 149, and the guiding portion 150 of the first embodiment, respectively.

As described above, the shaft member 141 of the first embodiment has the same diameter at the first swirl generating portion 143, the first bubble generating portion 145, the second swirl generating portion 147, and the second bubble generating portion 149. In the present embodiment, the diameter of a shaft portion 341-5 of the second swirl generating portion 347 is smaller than the diameter of a shaft portion 341-3 of the first bubble generating portion 345 or the diameter of a shaft portion 341-7 of the second bubble generating portion 349, as shown in FIG. 12. Accordingly, a shaft portion 341-4 between the first bubble generating portion 345 and the second swirl generating portion 347 is tapered such that its diameter gradually decreases and a shaft portion 341-6 between the second swirl generating portion 347 and the second bubble generating portion 349 is tapered such that its diameter gradually increases. By forming the tapered portion immediately before the second swirl generating portion 347, the flow path of the fluid is widened. Thus, the flow rate of the fluid flowing into the second swirl generating portion 347 increases, and the turning force of the fluid by the second swirl generating portion 347 becomes strong. Further, by forming the tapered portion between the second swirl generating portion 347 and the second bubble generating portion 349, the flow path of the fluid entering the second bubble generating portion 349 is sharply narrowed. As a result, the cavitation phenomenon can be amplified. This increases the bubble generating effect of the fluid supply pipe 300 and, consequently improves the cooling function and the cleaning effect of the fluid.

In the present embodiment, the length of a shaft portion 341-1 of the first swirl generating portion 343 (n2) is longer than the length of the fluid diffusing portion 342 (n1) and is shorter than the length of the shaft portion 341-3 the first bubble generating portion 345 (n4). The length of a shaft portion 341-2 (n3) is shorter than the length of the shaft portion 341-1 of the first swirl generating portion 343 (n2) and is shorter than the length of the fluid diffusing portion 342 (n1). The length of the shaft portion 341-5 of the second swirl generating portion 347 (n6) is the same as the length of the shaft portion 341-1 of the first swirl generating portion 343 (n2). The length of the shaft portion 341-4 (n5) is shorter than the length of the shaft portion 341-1 of the first swirl generating portion 343 (n2) and is shorter than the length of the shaft portion 341-5 of the second swirl generating portion 347 (n6). The length of the shaft portion 341-7 of the second bubble generating portion 349 (n8) is longer than the length of the shaft portion 341-3 of the first bubble generating portion 345 (n4). Further, the number of protrusions of the second bubble generating portion 349 is larger than the number of the protrusions of the first bubble generating portion 345. In addition, the length of the shaft portion 341-6 (n7) is shorter than the length of the shaft portion 341-5 of the second swirl generating portion 347 (n6) and is shorter than the length of the shaft portion 341-7 of the second bubble generating portion 349 (n8). Each of the length of the shaft portion 341-4 (n5) and the length of the shaft portion 341-6 (n7) is shorter than the length of the shaft portion 341-2 (n3). The present invention is not limited to the present embodiment. In another embodiment, the length of the shaft portion 341-3 of the first bubble generating portion 345 (n4) is the same as the length of the shaft portion 341-7 of the second bubble generating portion 349 (n8).

Although the fluid diffusing portion 342 has the cone shape in the present embodiment, the present invention is not limited thereto. In another embodiment, the fluid diffusing portion 342 is formed in a dome shape. In further another embodiment, the internal structure 340 includes no fluid diffusing portion. Further, the guiding portion 350 has the cone shape in the present embodiment. However, the present invention is not limited thereto. In another embodiment, the guiding portion 350 is formed in a dome shape. In further another embodiment, the internal structure 340 includes no guiding portion.

### Fourth Embodiment

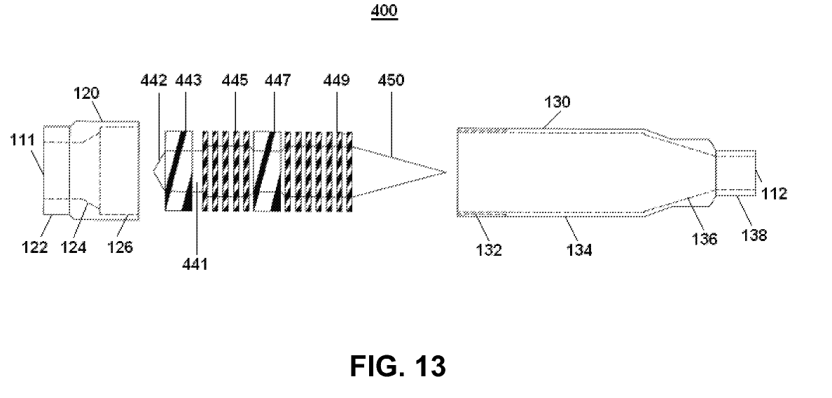

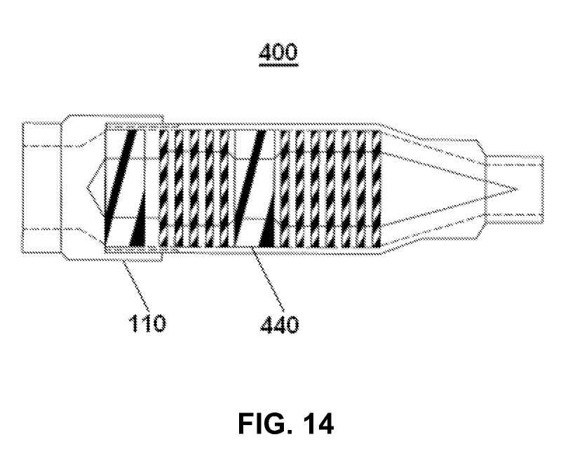

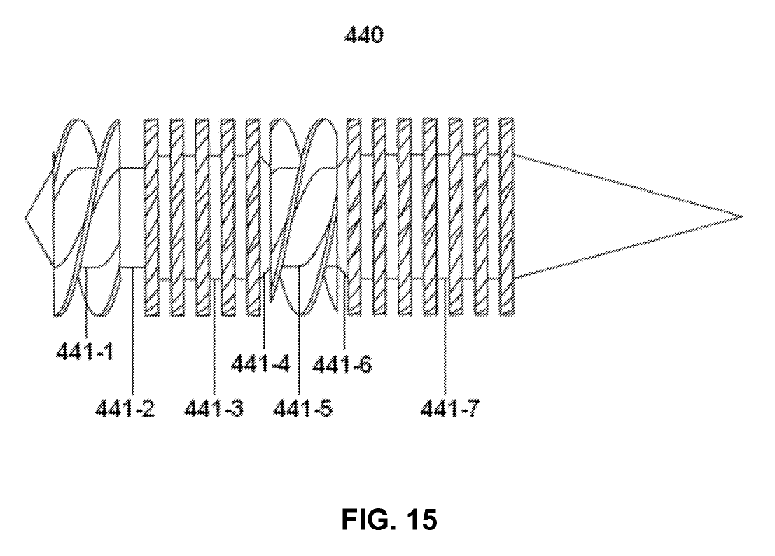

Referring to FIGS. 13 to 15, a fluid supply pipe 400 according to a fourth embodiment of the present invention will be described below. Descriptions of the same features as those of the first embodiment will be omitted, and only differences from the first embodiment will be described in detail. The same reference numerals are used for the same features as those of the first embodiment. FIG. 13 is a side exploded view of the fluid supply pipe 400 according to the fourth embodiment of the present invention, FIG. 14 is a side sectional view of the fluid supply pipe 400, and FIG. 15 is a side view of an internal structure 440 of the fluid supply pipe 400.

As shown in FIGS. 13 to 15, the fluid supply pipe 400 includes the pipe body 110 and the internal structure 440. Since the pipe body 110 of the fourth embodiment is the same as that of the first embodiment, descriptions thereof will be omitted. In FIGS. 13 and 14, a fluid flows from the inlet 111 to the outlet 112. As shown in FIG. 14, the fluid supply pipe 400 is assembled by inserting the internal structure 440 into the outlet side member 130 and then engaging the male screw 132 of the outer circumferential surface of the outlet side member 130 with the female screw 126 of the inner circumferential surface of the inlet side member 120.

The internal structure 440 of the fourth embodiment includes a fluid diffusing portion 442, a first swirl generating portion 443, a first bubble generating portion 445, a second swirl generating portion 447, a second bubble generating portion 449, and a conical guiding portion 450, from the upstream side to the downstream side, which are formed integrally on a common shaft member 441 having a circular cross-section. Each of the fluid diffusing portion 442, the first swirl generating portion 443, the first bubble generating portion 445, the second swirl generating portion 447, the second bubble generating portion 449, and the guiding portion 450 has a similar structure and can be formed by a similar method as each of the fluid diffusing portion 142, the first swirl generating portion 143, the first bubble generating portion 145, the second swirl generating portion 147, the second bubble generating portion 149, and the guiding portion 150 of the first embodiment, respectively.

As described above, the shaft member 141 of the first embodiment has the same diameter at the first swirl generating portion 143, the first bubble generating portion 145, the second swirl generating portion 147, and the second bubble generating portion 149. In the present embodiment, the diameter of a shaft portion 441-1 of the first swirl generating portion 443 and a shaft portion 441-2 is smaller than the diameter of a shaft portion 441-3 of the first bubble generating portion 445, as shown in FIG. 15. The diameter of a portion of the fluid diffusing portion 442 of which cross-sectional area is the maximum is the same as the diameter of the shaft portion 441-1 of the first swirl generating portion 443. Further, the diameter of a shaft portion 441-5 of the second swirl generating portion 447 is smaller than the diameter of the shaft portion 441-3 of the first bubble generating portion 445 or the diameter of a shaft portion 441-7 of the second bubble generating portion 449. A shaft portion 441-4 between the first bubble generating portion 445 and the second swirl generating portion 447 is tapered such that its diameter gradually decreases and a shaft portion 441-6 between the second swirl generating portion 447 and the second bubble generating portion 449 is tapered such that its diameter gradually increases. The diameter of the shaft portions 441-1 and 441-2 is the same as the diameter of the shaft portion 441-5.

Now, flow of the fluid passing through the fluid supply pipe 400 is described. The fluid enters the inlet 111 of the fluid supply pipe 400 through the delivery pipe 9 (see FIG. 1) bumps into the fluid diffusing portion 442 and diffuses outward from the center of the fluid supply pipe 400 (i.e. radially) while passing through the inner space of the tapered portion 124 of the inlet side member 120. The diffused fluid passes between three vanes of the first swirl generating portion 443 formed in the spiral shape. The fluid vigorously swirls due to the vanes of the first swirl generating portion 443 and is sent to the first bubble generating portion 445. Then, the fluid passes through a plurality of narrow flow paths formed by a plurality of rhombic protrusions of the first bubble generating portion 445. Since the diameter of the shaft portion 441-3 of the first bubble generating portion 445 is larger than the diameter of the shaft portion 441-1 of the first swirl generating portion 443 and the shaft portion 441-2, the path through which the fluid flows narrows sharply while the fluid flows from the first swirl generating portion 443 to the first bubble generating portion 445. Due to the structure of the first bubble generating portion 445, a large number of minute vortices generate in the fluid and the cavitation phenomenon occurs. As a result, fine bubbles are generated.

Then, the fluid passes between the three spiral vanes of the second swirl generating portion 447 and vigorously swirls due to the vanes. Since the diameter of the shaft portion 441-5 of the second swirl generating portion 447 is smaller than the diameter of the shaft portion 441-3 of the first bubble generating portion 445, a sufficient amount of flow gets into the second swirl generating portion 447 and the turning force of the fluid by the second swirl generating portion 447 becomes sufficiently strong. The swirling flow of the fluid is sent to the second bubble generating portion 449. Since the diameter of the shaft portion 441-7 of the second bubble generating portion 449 is larger than the diameter of the shaft portion 441-5 of the second swirl generating portion 447, the path through which the fluid flows is sharply narrowed while the fluid flows from the second swirl generating portion 447 to the second bubble generating portion 449. Due to the above described structure, a large number of minute vortices are generated and the cavitation phenomenon occurs. As a result, fine bubbles are generated in the fluid.

The fluid which has passed the second bubble generating portion 449 flows toward the end of the internal structure 440 and is guided to the center of the fluid supply pipe 400 along the surface of the guiding portion 450. The fluid passes the tapered portion 136 of the outlet side member 130 and flows out of the outlet 112. By the above described structure of the internal structure 440, an enough flow rate of the fluid flowing into the first and second swirl generating portions 443 and 447 can be secured and the turning force of the fluid by the first and second swirl generating portions 443 and 447 can become sufficiently strong. In addition, when the fluid enters the first bubble generating portion 445 and second bubble generating portion 449, the flow path of the fluid is sharply narrowed. As a result, the cavitation phenomenon can be amplified. By the two swirl generating portions and two bubble generating portions of the internal structure 440 of the fluid supply pipe 400, a plurality of fine bubbles are contained in the fluid discharged through the outlet 112 toward the workpiece W and the grinding blade 2. As described above, the fine bubbles decrease the surface tension of the fluid and thus the lubricity and penetrability are improved. Thus, it is possible to improve the cooling function and the cleaning effect of the fluid. Further, by the Coanda effect amplified by the guiding portion 450, the fluid adheres well to the grinding blade and the surface of the workpiece, thereby increasing the cooling effect. In addition, the swirling flow generated by the internal structure 440 causes mixture and diffusion, which is also useful when mixing two or more fluids having different properties.

Although the fluid diffusing portion 442 has the cone shape in the present embodiment, the present invention is not limited thereto. In another embodiment, the fluid diffusing portion 442 is formed in a dome shape. In further another embodiment, the internal structure 440 has no fluid diffusing portion. Further, the guiding portion 450 has the cone shape in the present embodiment. However, the present invention is not limited thereto. In another embodiment, the guiding portion 450 is formed in a dome shape. In further another embodiment, the internal structure 440 includes no guiding portion. In addition, the diameter of the shaft portion 441-2 is the same as the diameter of the shaft portion 441-1 of the first swirl generating portion 443, and the diameter of the shaft portions 441-1 and 441-2 is the same as the diameter of the shaft portion 441-5 in the present embodiment. However, the present invention is not limited thereto. In another embodiment, the shaft portion 441-2 is tapered such that the diameter of the shaft portion 441-2 increases gradually from the upstream side to the downstream side. In further another embodiment, the diameter of the shaft portions 441-1 and 441-2 is not the same as the diameter of the shaft portion 441-5.

### Fifth Embodiment

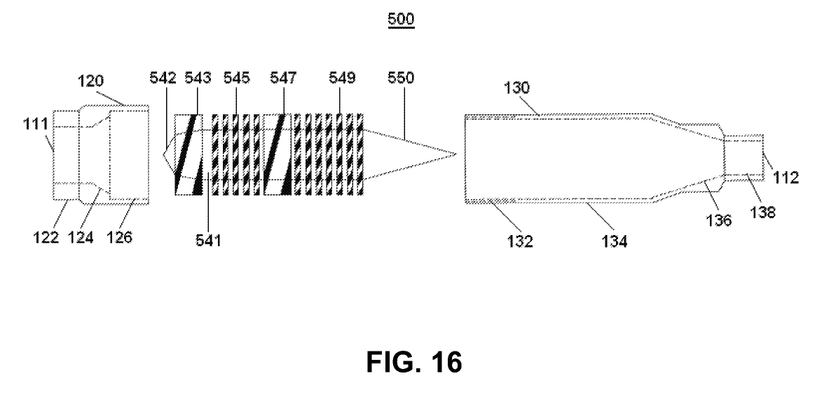

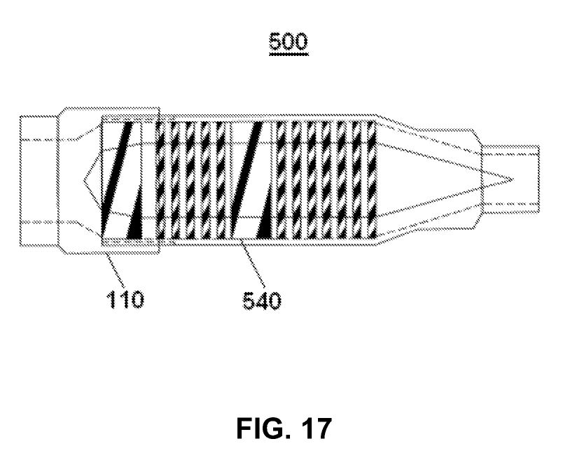

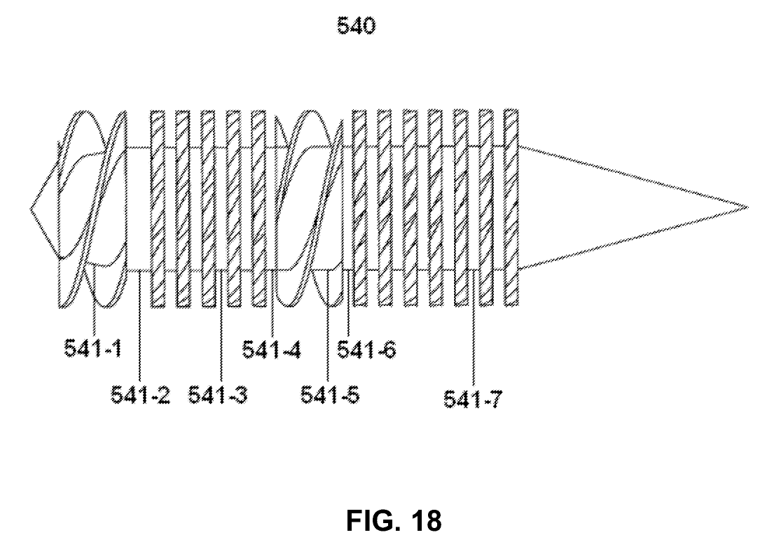

Referring to FIGS. 16 to 18, a fluid supply pipe 500 according to a fifth embodiment of the present invention will be described below. Descriptions of the same features as those of the first embodiment will be omitted, and only differences from the first embodiment will be described in detail. The same reference numerals are used for the same features as those of the first embodiment. FIG. 16 is a side exploded view of the fluid supply pipe 500 according to the fifth embodiment of the present invention, FIG. 17 is a side sectional view of the fluid supply pipe 500, and FIG. 18 is a side view of an internal structure 540 of the fluid supply pipe 500.

As shown in FIGS. 16 to 18, the fluid supply pipe 500 includes the pipe body 110 and the internal structure 540. Since the pipe body 110 of the fifth embodiment is the same as that of the first embodiment, descriptions thereof will be omitted. In FIGS. 16 and 17, a fluid flows from the inlet 111 to the outlet 112. As shown in FIG. 17, the fluid supply pipe 500 is assembled by inserting the internal structure 540 into the outlet side member 130 and then engaging the male screw 132 of the outer circumferential surface of the outlet side member 130 with the female screw 126 of the inner circumferential surface of the inlet side member 120.

The internal structure 540 of the fifth embodiment includes a fluid diffusing portion 542, a first swirl generating portion 543, a first bubble generating portion 545, a second swirl generating portion 547, a second bubble generating portion 549, and a conical guiding portion 550, from the upstream side to the downstream side, which are formed integrally on a common shaft member 541 having a circular cross-section. Each of the fluid diffusing portion 542, the first swirl generating portion 543, the first bubble generating portion 545, the second swirl generating portion 547, the second bubble generating portion 549, and the guiding portion 550 has a similar structure and can be formed by a similar method as each of the fluid diffusing portion 142, the first swirl generating portion 143, the first bubble generating portion 145, the second swirl generating portion 147, the second bubble generating portion 149, and the guiding portion 150 of the first embodiment, respectively.

As described above, the shaft member 141 of the first embodiment has the same diameter at the first swirl generating portion 143, the first bubble generating portion 145, the second swirl generating portion 147, and the second bubble generating portion 149. In the present embodiment, the diameter of a shaft portion 541-1 of the first swirl generating portion 543 increases gradually from the upstream side to the down stream side, as shown in FIG. 18. The shaft member 541 has the same diameter from a shaft portion 541-2 to a shaft portion 541-7 of the second bubble generating portion 549. The diameter of a portion of the fluid diffusing portion 542 of which cross-sectional area is the maximum is the same as the diameter of a portion of the shaft portion 541-1 of the first swirl generating portion 543 of which cross-sectional area is the minimum. The diameter of a portion of the shaft portion 541-1 of the first swirl generating portion 543 of which cross-sectional area is the maximum is the same as the diameter of the shaft portion 541-2 to the shaft portion 541-7 of the second bubble generating portion 549. Thus, an enough flow rate of the fluid can flow into the first swirl generating portion 543 and the turning force of the fluid by the first swirl generating portion 543 can become sufficiently strong. Further, since the diameter of the shaft portion 541-1 of the first swirl generating portion 543 gradually increases, it is possible to guide the fluid smoothly into a plurality of narrow flow paths formed by a plurality of protrusions of the first bubble generating portion 545. The above described structure of the fluid supply pipe 500 can improve the cooling function and the cleaning effect of the fluid.

Although the fluid diffusing portion 542 has the cone shape in the present embodiment, the present invention is not limited thereto. In another embodiment, the fluid diffusing portion 542 is formed in a dome shape. In further another embodiment, the internal structure 540 has no fluid diffusing portion. Further, the guiding portion 550 has the cone shape in the present embodiment. However, the present invention is not limited thereto. In another embodiment, the guiding portion 550 is formed in a dome shape. In further another embodiment, the internal structure 540 includes no guiding portion. In addition, the diameter of the portion of the shaft portion 541-1 of the first swirl generating portion 543 of which cross-sectional area is the maximum is the same as the diameter of a shaft portion 541-3 of the first bubble generating portion 545 in the present embodiment. However, the present invention is not limited thereto. In another embodiment, the diameter of the portion of the shaft portion 541-1 of the first swirl generating portion 543 of which cross-sectional area is the maximum is smaller than the diameter of the shaft portion 541-3, and the shaft portion 541-2 is tapered such that its diameter gradually increases.

### Sixth Embodiment

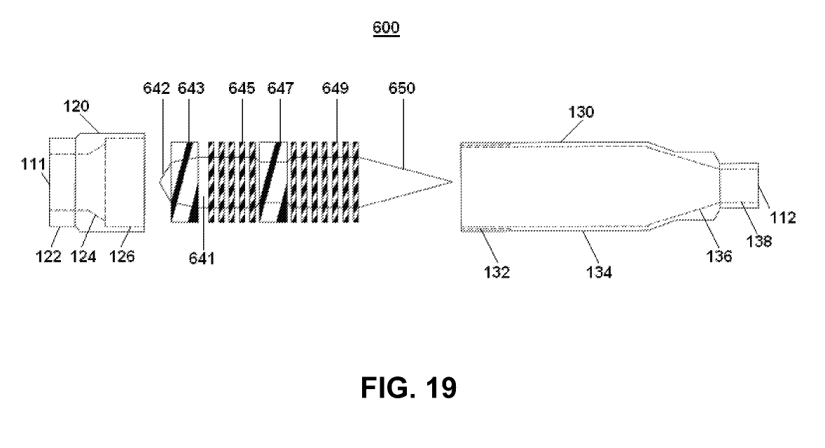

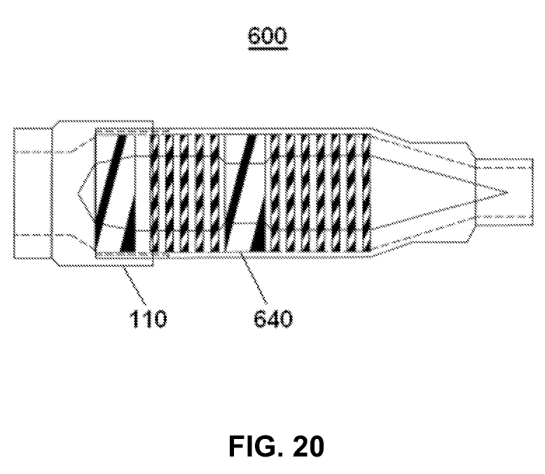

Referring to FIGS. 19 and 20, a fluid supply pipe 600 according to a sixth embodiment of the present invention will be described below. Descriptions of the same features as those of the first embodiment will be omitted, and only differences from the first embodiment will be described in detail. The same reference numerals are used for the same features as those of the first embodiment. FIG. 19 is a side exploded view of the fluid supply pipe 600 according to the sixth embodiment of the present invention and FIG. 20 is a side sectional view of the fluid supply pipe 600.

As shown in FIGS. 19 and 20, the fluid supply pipe 600 includes the pipe body 110 and an internal structure 640. Since the pipe body 110 of the sixth embodiment is the same as that of the first embodiment, descriptions thereof will be omitted. In FIGS. 19 and 20, a fluid flows from the inlet 111 to the outlet 112. As shown in FIG. 20, the fluid supply pipe 600 is assembled by inserting the internal structure 640 into the outlet side member 130 and then engaging the male screw 132 of the outer circumferential surface of the outlet side member 130 with the female screw 126 of the inner circumferential surface of the inlet side member 120.

The internal structure 640 of the sixth embodiment includes a fluid diffusing portion 642, a first swirl generating portion 643, a first bubble generating portion 645, a second swirl generating portion 647, a second bubble generating portion 649, and a conical guiding portion 650, from the upstream side to the downstream side, which are formed integrally on a common shaft member 641 having a circular cross-section. Each of the fluid diffusing portion 642, the first swirl generating portion 643, the first bubble generating portion 645, the second swirl generating portion 647, the second bubble generating portion 649, and the guiding portion 650 has a similar structure and can be formed by a similar method as each of the fluid diffusing portion 142, the first swirl generating portion 143, the first bubble generating portion 145, the second swirl generating portion 147, the second bubble generating portion 149, and the guiding portion 150 of the first embodiment, respectively.

As described above, the shaft member 141 of the first embodiment has the same diameter at the first swirl generating portion 143, the first bubble generating portion 145, the second swirl generating portion 147, and the second bubble generating portion 149. In the present embodiment, the diameter of a shaft portion of the first swirl generating portion 643 increases gradually from the upstream side to the down stream side, as shown in FIG. 19. The diameter of a portion of the fluid diffusing portion 642 of which cross-sectional area is the maximum is the same as the diameter of a portion of the shaft portion of the first swirl generating portion 643 of which cross-sectional area is the minimum. The diameter of a portion of the shaft portion of the first swirl generating portion 643 of which cross-sectional area is the maximum is the same as the diameter of a shaft portion of the first bubble generating portion 645. Thus, an enough flow rate of the fluid can flow into the first swirl generating portion 643 and the turning force of the fluid by the first swirl generating portion 643 can become sufficiently strong. Further, since the diameter of the shaft portion of the first swirl generating portion 643 gradually increases, it is possible to guide the fluid smoothly into a plurality of narrow flow paths formed by a plurality of protrusions of the first bubble generating portion 645.

The diameter of a shaft portion of the second swirl generating portion 647 is smaller than the diameter of the shaft portion of the first bubble generating portion 645 or the diameter of a shaft portion of the second bubble generating portion 649. Further, a shaft portion between the first bubble generating portion 645 and the second swirl generating portion 647 is tapered such that its diameter gradually decreases and a shaft portion between the second swirl generating portion 647 and the second bubble generating portion 649 is tapered such that its diameter gradually increases. By forming the tapered portion immediately before the second swirl generating portion 647, the flow path of the fluid is widened. Thus, an enough flow rate of the fluid flowing into the second swirl generating portion 647 can be secured, and the turning force of the fluid by the second swirl generating portion 647 can become sufficiently strong. Further, by forming the tapered portion between the second swirl generating portion 647 and the second bubble generating portion 649, the flow path of the fluid entering the second bubble generating portion 649 is sharply narrowed. As a result, the cavitation phenomenon can be amplified. The above described structure of the fluid supply pipe 600 improves the cooling function and the cleaning effect of the fluid compared with the conventional pipe.

Although the fluid diffusing portion 642 has the cone shape in the present embodiment, the present invention is not limited thereto. In another embodiment, the fluid diffusing portion 642 is formed in a dome shape. In further another embodiment, the internal structure 640 has no fluid diffusing portion. Further, the guiding portion 650 has the cone shape in the present embodiment. However, the present invention is not limited thereto. In another embodiment, the guiding portion 650 is formed in a dome shape. In further another embodiment, the internal structure 640 includes no guiding portion. In addition, the diameter of the portion of the shaft portion of the first swirl generating portion 643 of which cross-sectional area is the maximum is the same as the diameter of the shaft portion of the first bubble generating portion 645 in the present embodiment. However, the present invention is not limited thereto. In another embodiment, the diameter of the portion of the shaft portion of the first swirl generating portion 643 of which cross-sectional area is the maximum is smaller than the diameter of the shaft portion of the first bubble generating portion 645.

### Seventh Embodiment

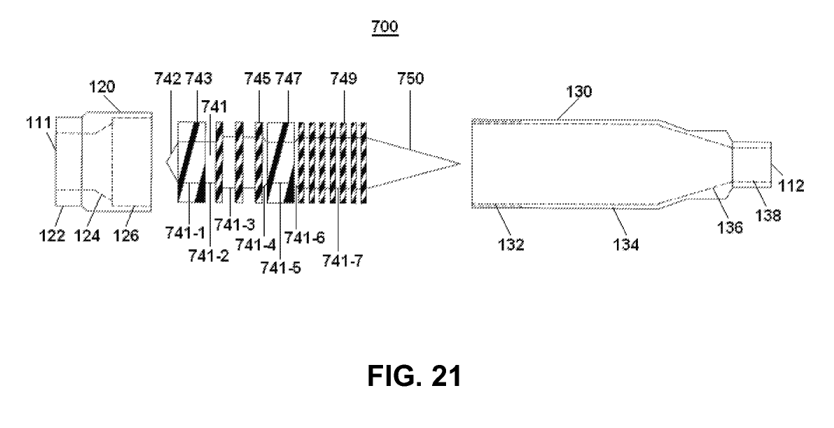

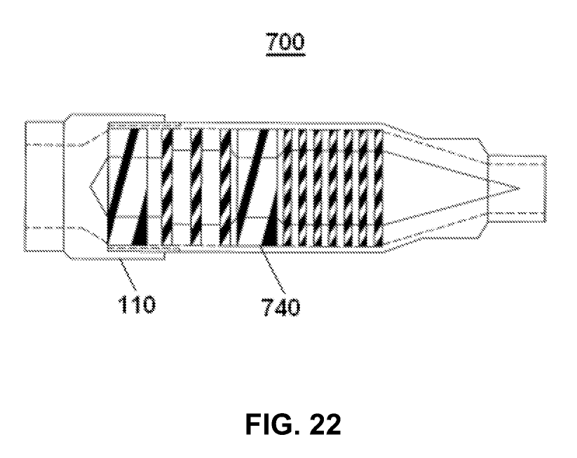

Referring to FIGS. 21 and 22, a fluid supply pipe 700 according to a seventh embodiment of the present invention will be described below. Descriptions of the same features as those of the first embodiment will be omitted, and only differences from the first embodiment will be described in detail. The same reference numerals are used for the same features as those of the first embodiment. FIG. 21 is a side exploded view of the fluid supply pipe 700 according to the seventh embodiment of the present invention and FIG. 22 is a side sectional view of the fluid supply pipe 700.

As shown in FIGS. 21 and 22, the fluid supply pipe 700 includes the pipe body 110 and an internal structure 740. Since the pipe body 110 of the sixth embodiment is the same as that of the first embodiment, descriptions thereof will be omitted. In FIGS. 21 and 22, a fluid flows from the inlet 111 to the outlet 112. As shown in FIG. 22, the fluid supply pipe 700 is assembled by inserting the internal structure 740 into the outlet side member 130 and then engaging the male screw 132 of the outer circumferential surface of the outlet side member 130 with the female screw 126 of the inner circumferential surface of the inlet side member 120.

The internal structure 740 of the seventh embodiment includes a fluid diffusing portion 742, a first swirl generating portion 743, a first bubble generating portion 745, a second swirl generating portion 747, a second bubble generating portion 749, and a conical guiding portion 750, from the upstream side to the downstream side, which are formed integrally on a common shaft member 741 having a circular cross-section. Each of the fluid diffusing portion 742, the first swirl generating portion 743, the first bubble generating portion 745, the second swirl generating portion 747, the second bubble generating portion 749, and the guiding portion 750 has a similar structure and can be formed by a similar method as each of the fluid diffusing portion 142, the first swirl generating portion 143, the first bubble generating portion 145, the second swirl generating portion 147, the second bubble generating portion 149, and the guiding portion 150 of the first embodiment, respectively.

The shaft member 741 of the fluid supply pipe 740 of the present embodiment is similar to the shaft member 441 of the fluid supply pipe 440 of the fourth embodiment. More specifically, the diameter of a shaft portion 741-1 of the first swirl generating portion 743 and a shaft portion 741-2 is smaller than the diameter of a shaft portion 741-3 of the first bubble generating portion 745. The diameter of a portion of the fluid diffusing portion 742 of which cross-sectional area is the maximum is the same as the diameter of the shaft portion 741-1 of the first swirl generating portion 743. Further, the diameter of a shaft portion 741-5 of the second swirl generating portion 747 is smaller than the diameter of the shaft portion 741-3 of the first bubble generating portion 745 or the diameter of a shaft portion 741-7 of the second bubble generating portion 749. A shaft portion 741-4 between the first bubble generating portion 745 and the second swirl generating portion 747 is tapered such that its diameter gradually decreases and a shaft portion 741-6 between the second swirl generating portion 747 and the second bubble generating portion 749 is tapered such that its diameter gradually increases. The diameter of the shaft portions 741-1 and 741-2 is the same as the diameter of the shaft portion 741-5.

The first bubble generating portion 745 has a significantly smaller number of rhombic protrusions than the second bubble generating portion 749, and the interval between the rhombic protrusions of the first bubble generating portion 745 is wider than that of the second bubble generating portion 749. Accordingly, a spiral-shaped flow path between the plurality of rhombic protrusions of the first bubble generating portion 745 is wider than a flow path between the plurality of rhombic protrusions of the second bubble generating portion 749, and the number of flow paths between the plurality of rhombic protrusions of the first bubble generating portion 745 is smaller than the number of flow paths between the plurality of rhombic protrusions of the second bubble generating portion 749. For example, while eight flow paths are formed in the first bubble generating portion 745, twelve flow paths are formed in the second bubble generating portion 749. By this, changes in the flow characteristics of the fluid (for example, generation of the fine bubbles due to the cavitation effect) occur more significantly at the second bubble generating portion 749, i.e. at the outlet side. Such a structure improves the cooling function and the cleaning effect of the fluid due to the significant changes in the flow characteristics of the fluid caused by the plurality of rhombic protrusions located in the outlet side, while lowering the processing cost.

The above described structure in which the number of the rhombic protrusions formed upstream is significantly smaller than the number of the rhombic protrusions formed downstream is applicable to any of the first to sixth embodiments. Although the fluid diffusing portion 742 has the cone shape in the present embodiment, the present invention is not limited thereto. In another embodiment, the fluid diffusing portion 742 is formed in a dome shape. In further another embodiment, the internal structure 740 has no fluid diffusing portion. Further, the guiding portion 750 has the cone shape in the present embodiment. However, the present invention is not limited thereto. In another embodiment, the guiding portion 750 is formed in a dome shape. In further another embodiment, the internal structure 740 includes no guiding portion. In addition, the diameter of the shaft portion 741-2 is the same as the the diameter of the shaft portions 741-1 of the first swirl generating portion 743 and the diameter of the shaft portions 741-1 and 741-2 is the same as the diameter of the shaft portion 741-5, in the present embodiment. However, the present invention is not limited thereto. In another embodiment, the shaft portion 741-2 is tapered such that its diameter increases gradually from the upstream side to the downstream side. In further another embodiment, the diameter of the shaft portion 741-1 and/or the shaft portion 741-2 is not the same as the diameter of the shaft portion 741-5.

According to each of the embodiments described above, the internal structure is configured to include two swirl generating portions and two bubble generating portions. However, according to another embodiment, an internal structure may have three or more swirl generating portions and three or more bubble generating portions. In this case, the shaft member may have a constant diameter over all the shaft portions similarly to the first embodiment or the second embodiment, the shaft member may have a tapered portion formed before and after the swirl generating portion in the downstream side similarly to the third embodiment, the diameter of the shaft portion of the swirl generating portion in the inlet side is smaller than the diameter of the shaft portion of the bubble generating portion similarly to the fourth embodiment, the diameter of the shaft portion of the swirl generating portion in the inlet side gradually increases similarly to the fifth embodiment, or the bubble generating portion in the inlet side may have a significantly smaller number of flow paths than the bubble generating portion in the downstream side similarly to the seventh embodiment. Those skilled in the art would recognize that various combinations of these features are available. Although the present invention have been described with respect to the examples in which the fluid supply pipe of the present invention is applied to a machine tool to discharge the coolant, the present invention is applicable to various applications for supplying one or more fluids. For example, the present invention is applicable to a household shower nozzle. When cold water and hot water flow into the fluid supply pipe, the flow characteristics described above are provided to the water by the internal structure and then discharged, thereby improving the cleaning effect. The present invention is also applicable to a fluid mixing apparatus. When a plurality of kinds of fluids having different properties flows into the fluid supply pipe, the flow characteristics described above are provided to the plural kinds of fluids by the internal structure, and these fluids are mixed and then discharged. In addition, by employing the fluid supply pipe of the present invention in a hydroponics system, it is possible to increase dissolved oxygen in water supplied by the system to maintain or raise the oxygen amount (i.e. dissolved oxygen concentration) in the water. The fluid supply pipe of the present invention can also be applied to any fluid having a high viscosity, and can change the viscosity or other properties of various fluids.

Although some embodiments of the present invention have been described above, the embodiments are for illustrative purposes only and not intended to limit the technical scope of the present invention. It will be apparent to those skilled in the art that many other possible embodiments and various modifications of the present invention may be made in light of the specification and drawings. Although a plurality of specific terms are used herein, they are used in a generic sense only for the purpose of explanation and are not used for the purpose of limiting the invention. The embodiments and modifications fall within the scope and the spirit of the invention described in this specification and within the scope of the invention as defined in the appended claims and equivalents thereof.

What is claimed is:

1. A fluid supply apparatus comprising:
an internal structure; and
a housing configured to house the internal structure, the housing having an inlet and an outlet,
the internal structure comprising a first portion, a second portion, a third portion, and a fourth portion, which are formed integrally on a common shaft member having a circular cross-section,
wherein the first portion is positioned upstream of the housing when the internal structure is housed in the housing and comprises a shaft portion and at least one spiral vane to swirl a fluid,
the second portion is positioned downstream from the first portion and comprises a shaft portion and a plurality of protrusions protruding from the outer circumferential surface of the shaft portion,
the third portion is positioned downstream from the second portion and comprises a shaft portion and at least one spiral vane to swirl a fluid, and
the fourth portion is positioned downstream from the third portion and comprises a shaft portion and a plurality of protrusions protruding from the outer circumferential surface of the shaft portion.

2. The fluid supply apparatus of claim 1, wherein the internal structure further comprises a fluid diffusing portion positioned upstream from the first portion and configured to diffuse a fluid flowing into the fluid supply apparatus through the inlet of the housing radially from the center, and
the fluid diffused by the fluid diffusing portion flows to the first portion.

3. The fluid supply apparatus of claim 2, wherein the fluid diffusing portion of the internal structure is one end of the internal structure formed in a cone or dome shape.

4. The fluid supply apparatus of claim 1, wherein the first portion of the internal structure comprises three vanes and each of the vanes has its end spaced by 120 degrees from each other in the circumferential direction of the shaft portion.

5. The fluid supply apparatus of claim 1, wherein the third portion of the internal structure comprises three vanes and each of the vanes has its end spaced by 120 degrees from each other in the circumferential direction of the shaft portion.

6. The fluid supply apparatus of claim 1, wherein the plurality of protrusions of the second portion of the internal structure are formed in a net shape and each of the plurality of protrusions is in the form of a pillar having a rhombic cross-section.

7. The fluid supply apparatus of claim 1, wherein the plurality of protrusions of the fourth portion of the internal structure are formed in a net shape and each of the plurality of protrusions is in the form of a pillar having a rhombic cross-section.

8. The fluid supply apparatus of claim 1, wherein the internal structure further comprises a guiding portion at the downstream end portion thereof which is configured to guide a fluid toward the center of the fluid supply apparatus.

9. The fluid supply apparatus of claim 8, wherein the guiding portion of the internal structure is one end of the internal structure formed in a cone shape.

10. The fluid supply apparatus of claim 8, wherein the guiding portion of the internal structure is one end of the internal structure formed in a dome shape.

11. The fluid supply apparatus of claim 1, wherein the shaft portion of the first portion, the shaft portion of the second portion, the shaft portion of the third portion, and the shaft portion of the fourth portion of the internal structure have the same diameter.

12. The fluid supply apparatus of claim 1, wherein the diameter of the shaft portion of the third portion of the internal structure is smaller than the diameter of the shaft portion of the fourth portion of the internal structure.

13. The fluid supply apparatus of claim 12, wherein the shaft member of the internal structure is tapered between the third portion and the fourth portion such that its diameter gradually increases.

14. The fluid supply apparatus of claim 1, wherein the diameter of the shaft portion of the third portion of the internal structure is smaller than the diameter of the shaft portion of the second portion of the internal structure.

15. The fluid supply apparatus of claim 14, wherein the shaft member of the internal structure is tapered between the second portion and the third portion such that its diameter gradually decreases.

16. The fluid supply apparatus of claim 1, wherein the diameter of the shaft portion of the third portion of the internal structure is smaller than the diameter of the shaft portion of the second portion of the internal structure, and the diameter of the shaft portion of the third portion is smaller than the diameter of the shaft portion of the fourth portion of the internal structure.

17. The fluid supply apparatus of claim 1, wherein the diameter of the shaft portion of the first portion of the internal structure is smaller than the diameter of the shaft portion of the second portion of the internal structure.

18. The fluid supply apparatus of claim 16, wherein the diameter of the shaft portion of the first portion of the internal structure is smaller than the diameter of the shaft portion of the second portion of the internal structure.

19. The fluid supply apparatus of claim 1, wherein the diameter of the shaft portion of the first portion of the internal structure increases gradually from the upstream side to the downstream side, the shaft portion of the second portion of the internal structure has a constant diameter, and
the diameter of a portion of the shaft portion of the first portion of which cross-sectional area is the maximum is the same as the diameter of the shaft portion of the second portion.

20. The fluid supply apparatus of claim 16, wherein the diameter of the shaft portion of the first portion of the internal structure increases gradually from the upstream side to the downstream side, the shaft portion of the second portion of the internal structure has a constant diameter, and
the diameter of a portion of the shaft portion of the first portion of which cross-sectional area is the maximum is the same as the diameter of the shaft portion of the second portion.

21. The fluid supply apparatus of claim 1, wherein the number of the protrusions of the second portion of the internal structure is smaller than the number of the protrusions of the fourth portion of the internal structure.

22. The fluid supply apparatus of claim 1, wherein the housing is a pipe body which comprises an inlet side member and an outlet side member, and the inlet side member and the outlet side member are connected by screw-joining.

23. The fluid supply apparatus of claim 1, wherein the internal structure further comprises a fifth portion and a sixth portion, which are formed integrally on the common shaft member,
the fifth portion is positioned downstream from the fourth portion and comprises a shaft portion and at least one spiral vane to swirl a fluid, and
the sixth portion is positioned downstream from the fifth portion and comprises a shaft portion and a plurality of protrusions protruding from the outer circumferential surface of the shaft portion.

24. An internal structure of a fluid supply apparatus, the fluid supply apparatus comprising a housing configured to house the internal structure, comprising:
a first portion, a second portion, a third portion, and a fourth portion, which are formed integrally on a common shaft member having a circular cross-section,
wherein the first portion is positioned upstream of the housing when the internal structure is housed in the housing and comprises a shaft portion and at least one spiral vane to swirl a fluid,
the second portion is positioned downstream from the first portion and comprises a shaft portion and a plurality of protrusions protruding from the outer circumferential surface of the shaft portion,
the third portion is positioned downstream from the second portion and comprises a shaft portion and at least one spiral vane to swirl a fluid, and
the fourth portion is positioned downstream from the third portion and comprises a shaft portion and a plurality of protrusions protruding from the outer circumferential surface of the shaft portion.

25. A machine tool comprising:
a fluid supply apparatus of claim 1,
wherein the machine tool allows coolant to flow into the fluid supply apparatus to provide a predetermined flow characteristic to the coolant and the coolant is discharged from the fluid supply apparatus to a tool or a workpiece to cool it.

26. A shower nozzle comprising:
a fluid supply apparatus of claim 1,
wherein water of a predetermined temperature flows into the fluid supply apparatus, a predetermined flow characteristic is provided to the water, and the shower nozzle discharges the water from the fluid supply apparatus to improve a cleaning effect.

27. A fluid mixing apparatus comprising:
a fluid supply apparatus of claim 1,
wherein the fluid mixing apparatus allows a plurality of fluids having different properties to flow into the fluid supply apparatus to provide a predetermined flow characteristic to the fluids to mix them and discharges the mixed fluids.

28. A hydroponics system comprising:
a fluid supply apparatus of claim 1,
wherein the hydroponics system allows water to flow into the fluid supply apparatus to increase dissolved oxygen in the water, and the water is discharged from the fluid supply apparatus.
